(19) United States
(12) Patent Application Publication
(10) Pub. No.: US 2012/0019210 A1
(43) Pub. Date: Jan. 26, 2012

(54) DC POWER SUPPLY SYSTEM AND OUTPUT CONTROL METHOD

(76) Inventors: Akira Wakamatsu, Tokyo (JP); Katsuya Hirano, Tokyo (JP)

(21) Appl. No.: 13/262,054

(22) PCT Filed: Apr. 14, 2010
(86) PCT No.: PCT/JP2010/056682

§ 371 Date: Sep. 29, 2011

(30) Foreign Application Priority Data
Apr. 15, 2009 (JP) 2009098839

(51) Int. Cl. H02J 7/00

(52) U.S. Cl. 320/134

(57) ABSTRACT

Suppliable power per unit time from a secondary battery (4) to a DC communication device load (3) during an output suppression time zone (TS) is stored in a memory (2B) as a threshold (W1). A current power consumption (W2) of the DC communication device load (3) is measured. An output control unit (2D) is provided with a function of, during the output suppression time zone (TS), comparing the current power consumption (W2) of the DC communication device load (3) with the threshold (W1) in the memory (2B), if W2≦W1, stopping power supply from a rectifying unit (2-1) to the DC communication device load (3) and covering the power consumption (W2) only by power accumulated in the secondary battery (4), and if W2>W1, covering the power consumption up to the threshold (W1) by the power accumulated in the secondary battery (4) and covering the power consumption more than the threshold (W1) by power from the rectifying unit (2-1).

### TECHNICAL FIELD

The present invention relates to a DC power supply system which supplies power to a DC load such as a DC communication device load whose power consumption varies, and an output control method applied to the DC power supply system.

### BACKGROUND ART

FIG. 6 shows the main part of an associated DC power supply system. Referring to FIG. 6, reference numerals 10 denotes a commercial AC power supply; 20, a rectifier; 30, a DC communication device load (DC load); and 40, a secondary battery. The rectifier 20 includes a rectifying unit 20-1 that rectifies and converts AC power from the commercial AC power supply 10 into DC power, a charge/discharge unit 20-2 provided in the supply path of the DC power from the rectifying unit 20-1 to the secondary battery 40, a feedback information monitoring unit 20-3 that monitors a current or a voltage to the DC communication device load 30 as feedback information, and a control unit 20-4 that controls the operations of the rectifying unit 20-1 and the charge/discharge unit 20-2 upon receiving the feedback information from the feedback information monitoring unit 20-3. In this DC power supply system, the DC communication device load 30 operates continuously on a 24-hour basis in 365 days while varying its power consumption. Note that the feedback information to the control unit 20-4 includes the temperature of the rectifier 20 itself and the like.

[Method of Using Secondary Battery as Backup Power Supply in Case of Emergency]

FIG. 7 shows the daily variations with time of the commercial AC power consumption of the rectifier 20 and the power consumption of the DC communication device load 30 when using the secondary battery 40 as the backup power supply in case of emergency. Referring to FIG. 7, a characteristic I shown by the solid line represents the variation with time of the commercial AC power consumption of the rectifier 20. A characteristic II shown by the dotted line represents the variation with time of the power consumption of the DC communication device load 30.

In this method, during all time zones of a day, the power from the rectifying unit 20-1 covers the power consumption of the DC communication device load 30, and additionally, the power from the rectifying unit 20-1 floating-charges the secondary battery 40. In this case, upon detecting, for example, an abnormality of the rectifying unit 20-1 based on the feedback information from the feedback information monitoring unit 20-3, the control unit 20-4 stops power supply from the rectifying unit 20-1 to the DC communication device load 30. The control unit 20-4 then sets the charge/discharge unit 20-2 in the discharge mode to supply the power accumulated in the secondary battery 40 to the DC communication device load 30 (for example, see patent literature 1).

[Method of Performing Peak Shift Control Using Secondary Battery]

FIG. 8 shows a variation (I) with time of the commercial AC power consumption of the rectifier 20 and a variation (II) with time of the power consumption of the DC communication device load 30 when performing peak shift control using the secondary battery 40.

In this method, the time zone of, for example, 8:00 to 20:00 of a day is defined as the peak shift time zone. In this case, during the peak shift time zone, power supply from the rectifying unit 20-1 to the DC communication device load 30 is stopped, and the power consumption of the DC communication device load 30 is covered only by the power accumulated in the secondary battery 40. During the time zones other than the peak shift time zone, the rectifying unit 20-1 supplies power to the DC communication device load 30 and charges the secondary battery 40 (for example, see patent literature 2).

[Method of Performing Peak Cut Control Using Secondary Battery]

FIG. 9 shows a variation (I) with time of the commercial AC power consumption of the rectifier 20 and a variation (II) with time of the power consumption of the DC communication device load 30 when performing peak cut control using the secondary battery 40.

In this method, the time zone of, for example, 8:00 to 20:00 of a day is defined as the peak cut time zone. In addition, a predetermined power value is defined as a peak cut threshold Wth for the power consumption of the DC communication device load 30. In this case, during the peak cut time zone, if the power consumption of the DC communication device load 30 is equal to or smaller than the peak cut threshold Wth, the power consumption of the DC communication device load 30 is covered only by the power from the rectifying unit 20-1. During the peak cut time zone, if the power consumption of the DC communication device load 30 exceeds the peak cut threshold Wth, the power consumption up to the peak cut threshold Wth is covered by the power from the rectifying unit 20-1 while the power consumption more than the peak cut threshold Wth is covered by the power accumulated in the secondary battery 40. During the time zones other than the peak cut time zone, the rectifying unit 20-1 supplies power to the DC communication device load 30 and charges the secondary battery 40 (for example, see patent literature 3).

### Related Art Literature

### Patent Literature

Patent Literature 1: Japanese Patent Laid-Open No. 9-322433

Patent Literature 2: Japanese Patent Laid-Open No. 2003-17135

Patent Literature 3: Japanese Patent Laid-Open No. 2002-369407

### DISCLOSURE OF INVENTION

### Problems to be Solved by the Invention

However, in the method of using the secondary battery as the backup power supply in case of emergency described with reference to FIG. 7, the rectifying operation of the rectifying unit is performed all the day. No consideration is given to reduce the amount of carbon dioxide generated by the commercial AC power consumption of the rectifier.

On the other hand, in the method of performing peak shift control using the secondary battery described with reference to FIG. 8, the power consumption of the DC communication device load is covered only by the power accumulated in the secondary battery in the peak shift time zone. Hence, the amount of carbon dioxide generated by the commercial AC power consumption of the rectifier in the peak shift time zone decreases. In this method, however, both the secondary battery and the rectifier inevitably become bulky.

For example, the capacity of suppliable power of the secondary battery used in the example shown in FIG. 7 is represented by 52 cells. To the contrary, in the example shown in FIG. 8, the secondary battery needs to discharge power corresponding to a capacity of 81 cells. In this case, 52 cells-81 cells=−29 cells. That is, the capacity of the secondary battery is 29 cells short. Note that to make the secondary battery discharge the power corresponding to the capacity of 81 cells, it needs to charge power corresponding to 89 cells assuming that 10% of the discharge amount (81 cells) is the charge loss for both the charge efficiency of the secondary battery and the conversion efficiency of the rectifier.

As is apparent from this example, in the method of performing peak shift control using the secondary battery, the capacity of the secondary battery needs to be large, and both the secondary battery and the rectifier inevitably become bulky.

In the method of performing peak cut control using the secondary battery described with reference to FIG. 9, the power consumption of the DC communication device load more than the peak cut threshold Wth is covered by the power accumulated in the secondary battery in the peak cut time zone. Hence, the used electric energy of the secondary battery is small, and its capacity need not be increased.

For example, the capacity of suppliable power of the secondary battery used in the example shown in FIG. 7 is represented by 52 cells. To the contrary, in the example shown in FIG. 9, the secondary battery only needs to discharge power corresponding to a capacity of 35 cells. In this case, 52 cells−35 cells=17 cells. That is, the capacity of the secondary battery has a surplus corresponding to 17 cells. Note that to make the secondary battery discharge the power corresponding to the capacity of 35 cells, it needs to charge power corresponding to 39 cells assuming that 10% of the discharge amount (35 cells) is the charge loss for both the charge efficiency of the secondary battery and the conversion efficiency of the rectifier.

As is apparent from this example, in the method of performing peak cut control using the secondary battery, the capacity of the secondary battery need not be large.

In this method, however, the power consumption of the DC communication device load equal to or smaller than the peak cut threshold Wth is wholly covered by the power from the rectifying unit in the peak cut time zone. For this reason, the decrease amount of carbon dioxide generated by the commercial AC power consumption of the rectifier in the peak cut time zone is small, and the generation amount of carbon dioxide cannot largely be decreased.

The present invention has been made to solve the above-described problems, and has as its exemplary object to provide a DC power supply system and an output control method capable of largely contributing to reduction of a carbon dioxide generation amount by increasing the decrease amount of carbon dioxide generated by the commercial AC power consumption of the rectifier in a desired time zone without making facilities such as the secondary battery and the rectifier bulky.

### Means of Solution to the Problems

In order to achieve the above-described exemplary object, a DC power supply system according to an exemplary aspect of the invention includes a DC load whose power consumption varies, a rectifying unit that rectifies and converts AC power into DC power, a secondary battery to be charged upon receiving the DC power supplied from the rectifying unit, output suppression time zone setting means for setting an output suppression time zone defined as a desired time zone, threshold storage means for storing, as a threshold W1, suppliable power per unit time from the secondary battery to the DC load during the output suppression time zone, power consumption measuring means for measuring a current power consumption of the DC load, output control means for, during the output suppression time zone, comparing the threshold W1 with the current power consumption of the DC load measured by the power consumption measuring means, if the current power consumption of the DC load is not more than the threshold W1, stopping power supply from the rectifying unit to the DC load and covering the power consumption only by power accumulated in the secondary battery, and if the current power consumption of the DC load is more than the threshold W1, covering the power consumption up to the threshold W1 by the power accumulated in the secondary battery and covering the power consumption more than the threshold W1 by power from the rectifying unit.

### Effect of the Invention

According to the present invention, the desired time zone is set as the output suppression time zone. The suppliable power per unit time from the secondary battery to the DC load during the output suppression time zone is defined as the threshold W1. During the output suppression time zone, the power consumption of the DC load equal to or smaller than the threshold W1 is wholly covered by the power from the secondary battery. Only the power consumption of the DC load larger than the threshold W1 is covered by the power from the rectifying unit. It is therefore possible to largely contribute to reduction of the carbon dioxide generation amount by increasing the decrease amount of carbon dioxide generated by the commercial AC power consumption of the rectifier in the desired time zone without making the facilities such as the secondary battery and the rectifier bulky.

### BRIEF DESCRIPTION OF DRAWINGS

FIG. 1 is a block diagram showing the main part of a DC power supply system according to the first exemplary embodiment of the present invention;

FIG. 2 is a timing chart for explaining the output suppression operation of an output control unit during the output suppression time zone of the DC power supply system according to the first exemplary embodiment;

FIG. 3 is a timing chart for explaining an example in which the discharge amount of a secondary battery is maximized while the commercial AC power consumption of a rectifier is minimized during the output suppression time zone of the DC power supply system according to the first exemplary embodiment;

FIG. 4 is a block diagram showing the main part of a DC power supply system according to the second exemplary embodiment of the present invention;

FIG. 5 is a flowchart for explaining the output suppression operation of an output control unit during the output suppression time zone of the DC power supply system according to the second exemplary embodiment;

FIG. 6 is a block diagram showing the main part of an associated DC power supply system;

FIG. 7 is a timing chart showing the daily variations with time of the commercial AC power consumption of a rectifier and the power consumption of a DC communication device load when using a secondary battery as a backup power supply in case of emergency in the associated DC power supply system;

FIG. 8 is a timing chart showing the daily variations with time of the commercial AC power consumption of the rectifier and the power consumption of the DC communication device load when performing peak shift control using the secondary battery in the associated DC power supply system; and

FIG. 9 is a timing chart showing the daily variations with time of the commercial AC power consumption of the rectifier and the power consumption of the DC communication device load when performing peak cut control using the secondary battery in the associated DC power supply system.

### BEST MODE FOR CARRYING OUT THE INVENTION

The present invention will now be described in detail with reference to the accompanying drawings.

### First Exemplary Embodiment

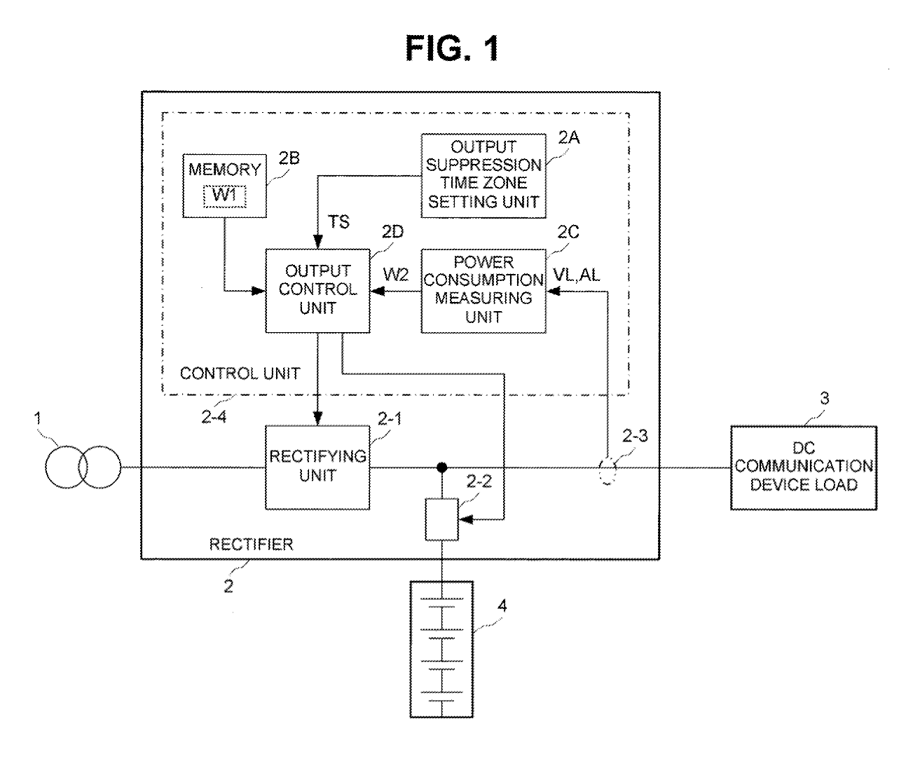

FIG. 1 is a block diagram showing the main part of a DC power supply system according to the first exemplary embodiment of the present invention. Referring to FIG. 1, reference numerals 1 denotes a commercial AC power supply; 2, a rectifier; 3, a DC communication device load (DC load); and 4, a secondary battery. The rectifier 2 includes a rectifying unit 2-1 that rectifies and converts AC power from the commercial AC power supply 1 into DC power, a charge/discharge unit 2-2 provided in the supply path of the DC power from the rectifying unit 2-1 to the secondary battery 4, a feedback information monitoring unit 2-3 that monitors a current or a voltage to the DC communication device load 3 as feedback information, and a control unit 2-4 that controls the operations of the rectifying unit 2-1 and the charge/discharge unit 2-2 upon receiving the feedback information from the feedback information monitoring unit 2-3. In this DC power supply system, the DC communication device load 3 operates continuously on a 24-hour basis in 365 days while varying its power consumption. Note that the feedback information to the control unit 2-4 includes The temperature of the rectifier 2 itself and the like.

In the first exemplary embodiment, the control unit 2-4 of the rectifier 2 includes an output suppression time zone setting unit 2A that sets an output suppression time zone TS defined as a desired time zone, a memory (internal storage device) 2B that stores, as a threshold W1, the suppliable power per unit time from the secondary battery 4 to the DC communication device load 3 during the output suppression time zone TS, a power consumption measuring unit 2C that measures a current power consumption W2 (W2=VL×AL) of the DC communication device load 3 from a load voltage VL and a load current AL included in the feedback information from The feedback information monitoring unit 2-3, and an output control unit 2D that controls the operations of the rectifying unit 2-1 and the charge/discharge unit 2-2 based on the output suppression time zone TS from the output suppression time zone setting unit 2A, the threshold W1 stored in the memory 2B, and the current power consumption W2 of the DC communication device load 3 from the power consumption measuring unit 2C.

Note that in the first exemplary embodiment, the output suppression time zone TS is designated in advance as the time zone of 8:00 to 20:00. In the first exemplary embodiment, letting Cb be the capacity [Wh] of the secondary battery 4 (secondary battery capacity), Td be the time width [hr] of the output suppression time zone TS, and Ldod be the limit [%] of the depth of discharge of the secondary battery 4, the threshold W1 given by

W1=Cb×Ldod/Td[W] (1)

is stored in the memory 2B.

The threshold W1 is continuously held in the memory 2B unless one of Cb, Ldod, and Td is changed by the user. That is, if Cb, Ldod, and Td are not changed, the threshold W1 is held in the memory 2B as a fixed value. In the first exemplary embodiment, the control unit 2-4 is implemented by hardware including a processor and a storage device and programs that implement various functions in cooperation with the hardware.

In the first exemplary embodiment, the output control unit 2D controls the operations of the rectifying unit 2-1 and the charge/discharge unit 2-2 in the following way.

The output control unit 2D performs a normal control operation (normal operation) for the rectifying unit 2-1 and the charge/discharge unit 2-2 until the current time enters the output suppression time zone TS. In this normal operation, the charge/discharge unit 2-2 is set in the charge mode to charge the secondary battery 4 by the power from the rectifying unit 2-1. In addition, the power consumption of the DC communication device load 3 is wholly covered by the power from the rectifying unit 2-1.

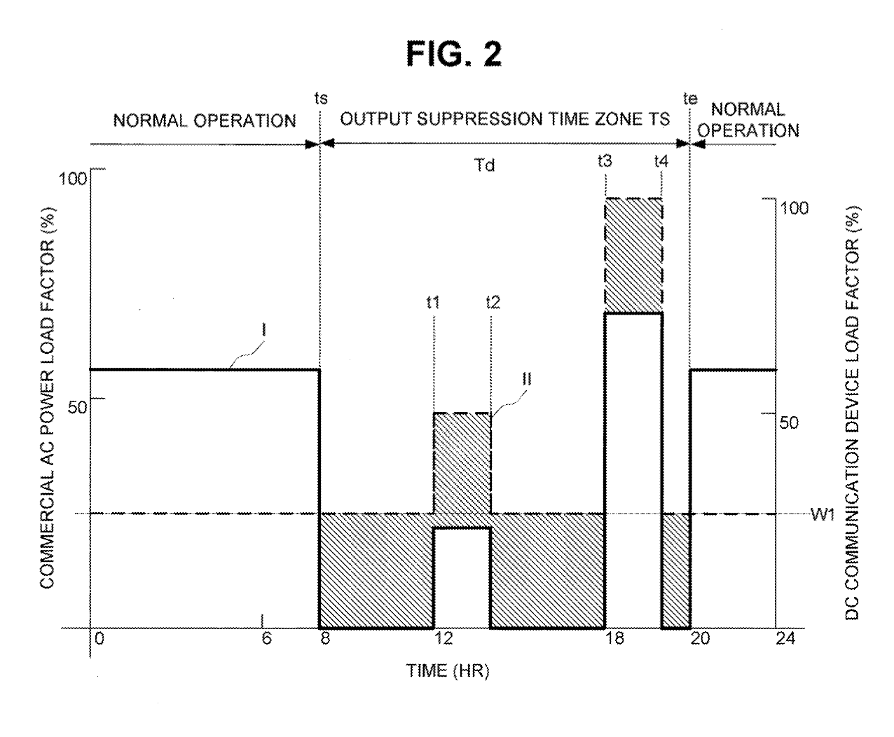

When the current time has entered the output suppression time zone TS (point is shown in FIG. 2), the output control unit 2D turns on output suppression control to start the suppression operation of the output from the rectifying unit 2-1.

In this case, the output control unit 2D compares the current power consumption W2 of the DC communication device load 3 from the power consumption measuring unit 2C with the threshold W1 stored in the memory 2B. If the current power consumption W2 of the DC communication device load 3 is equal to or smaller than the threshold W1 (W2≦W1), the output control unit 2D stops power supply from the rectifying unit 2-1 to the DC communication device load 3. The output control unit 2D then sets the charge/discharge unit 2-2 in the discharge mode to cover the power consumption W2 only by the power accumulated in the secondary battery 4. If the current power consumption W2 of the DC communication device load 3 exceeds the threshold W1 (W2>W1), the power consumption up to the threshold W1 is covered by the power accumulated in the secondary battery 4 while the power consumption more than the threshold W1 is covered by the power from The rectifying unit 2-1.

In the example of FIG. 2, in the intervals of points t1 to t2 and points t3 to t4, the power consumption W2 of the DC communication device load 3 exceeds the threshold W1. Hence, the power consumption up to the threshold W1 is covered by the power accumulated in the secondary battery 4 while the power consumption more than the threshold W1 is covered by the power from the rectifying unit 2-1. In the intervals of the points is to t1, the points t2 to t3, and the points t4 to te, the power consumption W2 of the DC communication device load 3 is equal to or smaller than the threshold W1. Hence, the power consumption W2 is [symbol] power accumulated in the secondary battery 4.

When the current time falls outside the output suppression time zone TS (the point to shown in FIG. 2), the output control unit 2D turns off the output suppression control to return to the normal control operation before the output suppression time zone TS starts. That is, the output control unit 2D returns to the normal operation, and sets the charge/discharge unit 2-2 in the charge mode to start charging the secondary battery 4 by the power from the rectifying unit 2-1. The power consumption of the DC communication device [symbol] covered by the power from the rectifying unit 2-1.

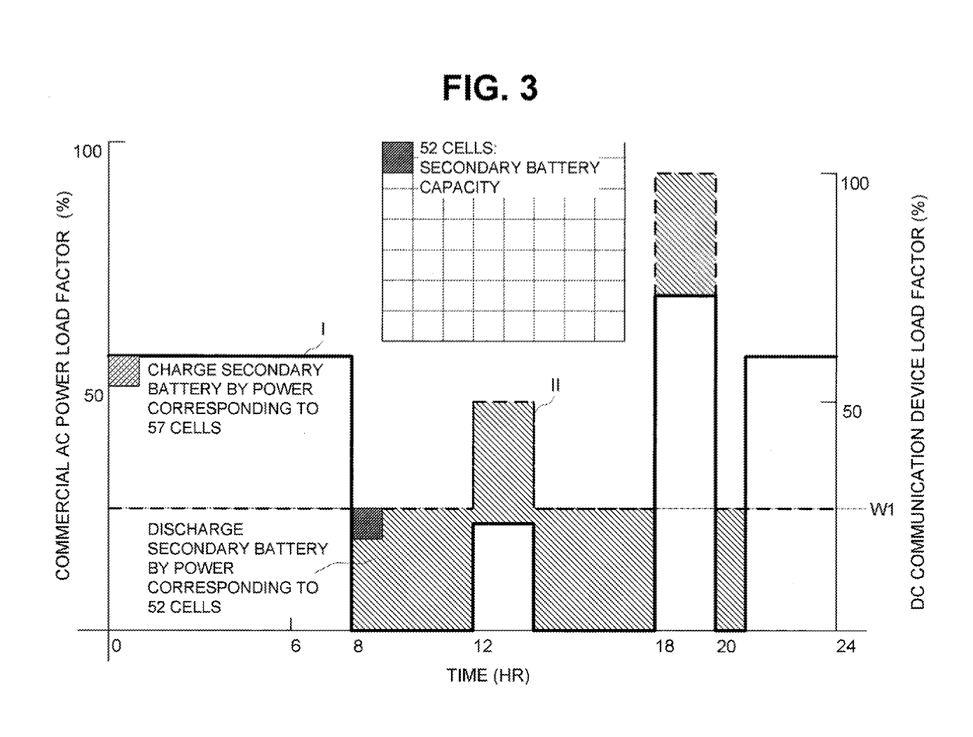

FIG. 2 shows an example in which out of the power accumulated in the secondary battery 4, all power suppliable to the DC communication device load 3 is used during the output suppression time zone TS. In this case, the capacity of the suppliable power of the secondary battery 4 is represented by 52 cells, as shown in FIG. 3. Assume that the secondary battery 4 is charged by power corresponding to 57 cells including the charge loss (the charge loss is 10% of the charge amount (52 cells) for both the charge efficiency of the [symbol] and the conversion efficiency of the rectifier). All the suppliable power of the secondary battery 4 is supplied to the DC communication device load 3, and only the power consumption that cannot be covered by the secondary battery 4 is covered by the power from the rectifying unit 2-1. That is, in this case, 52 cells−52 cells=0. The discharge amount of the secondary battery 4 is maximized, and the commercial AC power consumption of the rectifier 2 is minimized so that the decrease amount of generated carbon dioxide increases during the output suppression time zone TS.

Note that in the output suppression time zone TS, if the power consumption W2 of the DC communication device load 3 is smaller than the threshold W1, the power suppliable to the DC communication device load 3 remains in the secondary battery 4 at the end point to of the output suppression time zone TS. In this case, the discharge amount of the secondary battery 4 is not maximized, and the commercial AC power consumption of the rectifier 2 is not minimized in the output suppression time zone TS. Even in such a case, however, the discharge amount of the secondary battery 4 increases, and the commercial AC power consumption of the rectifier 2 decreases, in the output suppression time zone TS so that the decrease amount of generated carbon dioxide increases during the output suppression time zone TS.

As described above, in the first exemplary embodiment, the desired time zone is set as the output suppression time zone TS. The suppliable power per unit time from the secondary battery 4 to the DC communication device load 3 during the output suppression time zone TS is defined as the threshold W1. During the output suppression time zone TS, the power consumption W2 of the DC communication device load 3 [symbol] to or smaller than the threshold W1 is wholly covered by the power from the secondary battery 4. Only the power consumption W2 larger than the threshold W1 is covered by the power from the rectifying unit 2-1. It is therefore possible to largely contribute to reduction of the carbon dioxide generation amount by increasing the decrease amount of carbon dioxide generated by the commercial AC power consumption of the rectifier 2 in the desired time zone without making the facilities such as the secondary battery 4 and the rectifier 2 bulky. In addition, according to the first exemplary embodiment, the communication device operation cost can be reduced by appropriately setting the output suppression time zone TS defined as the desired time zone so as to reduce the commercial AC power consumption during the daytime with a high electricity rate and charge the secondary battery 4 during the nighttime with a low electricity rate.

In the first exemplary embodiment, the output suppression time zone setting unit 2A corresponds to an output suppression time zone setting means of the present invention, the memory 2B corresponds to a threshold storage means, the power consumption measuring unit 2C corresponds to a power consumption measuring means, and the output control unit 2D corresponds to an output control means.

### Second Exemplary Embodiment

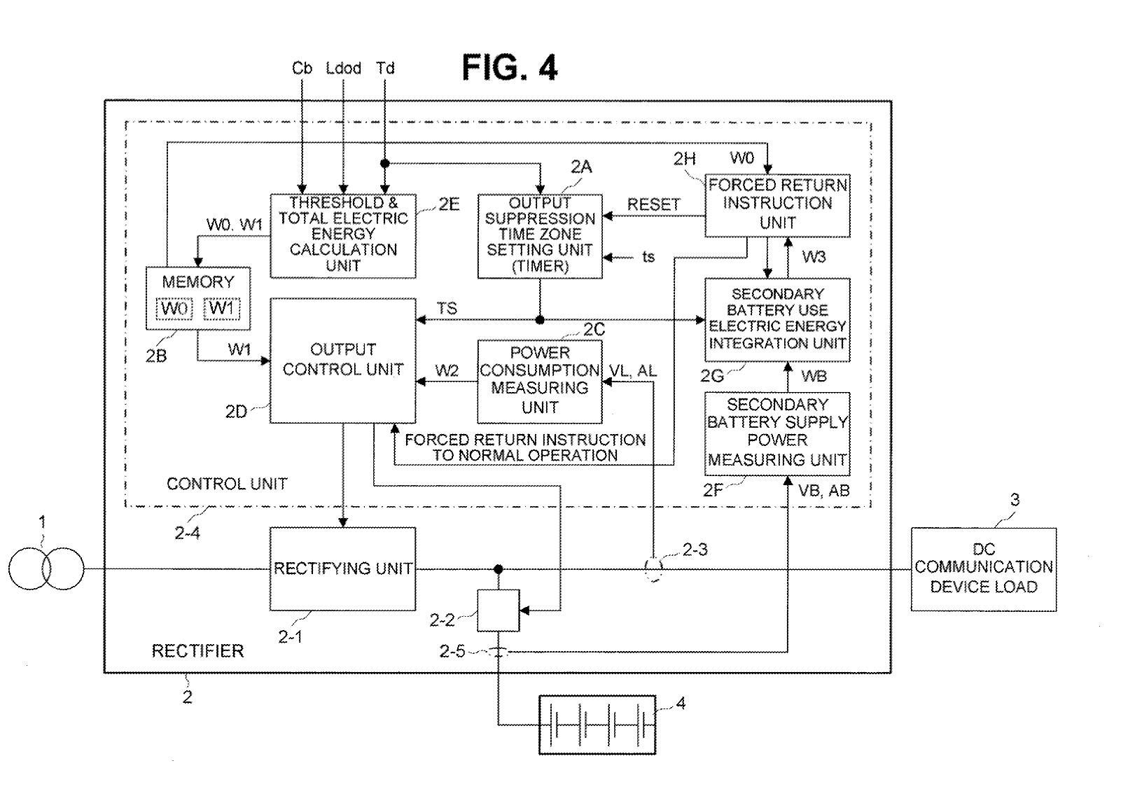

FIG. 4 is a block diagram showing the main part of a DC power supply system according to the second exemplary embodiment of the present invention. The same reference numerals as in FIG. 1 denote the same or similar constituent elements in FIG. 4, and a description thereof will be omitted.

In the second exemplary embodiment, a control unit 2-4 includes a threshold & total electric energy calculation unit 2E. The Threshold & total electric energy calculation unit 2E obtains a threshold W1 as W1=Cb×Ldod/Td [W] from a capacity (secondary battery capacity) Cb [Wh] of a secondary battery 4, a time width Td [hr] of an output suppression time zone TS, and a limit Ldod [%] of the depth of discharge of the secondary battery 4 which are given as arbitrary parameters, and stores the obtained threshold W1 in a memory 2B. The threshold & total electric energy calculation unit 2E also obtains a total electric energy W0 of the secondary battery 4 as W0=Cb×Ldod [Wh] and stores the obtained total electric energy W0 in the memory 2B.

In the second exemplary embodiment, the time width Td of the output suppression time zone TS to the threshold & total electric energy calculation unit 2E is sent to an output suppression time zone setting unit 2A. The output suppression time zone setting unit 2A starts a timer to count the time width Td from the point of time the current time has reached a start time is of the output suppression operation, and sends the timer count signal to an output control unit 2D and a secondary battery used electric energy integration unit 2G to be described later, thereby setting the output suppression time zone TS in the output control unit 2D and the secondary battery used electric energy integration unit 2G.

In the second exemplary embodiment, a rectifier 2 includes a secondary battery feedback information monitoring unit 2-5 that monitors a battery voltage VB of the secondary battery 4 or a discharge current AB from the secondary battery 4 as feedback information. The control unit 2-4 includes a secondary battery supply power measuring unit 2F that measures a supply power WB from the secondary battery 4 to a DC communication device load 3 based on the battery voltage VB and the discharge current AB included in the feedback information from the secondary battery feedback information monitoring unit 2-5, the secondary battery used electric energy integration unit 2G that receives the setting of the output suppression time zone TS from the output suppression time zone setting unit 2A and integrates the supply power WB from the secondary battery 4 to the DC communication device load 3 during the output suppression time zone TS as a used electric energy W3 of the secondary battery 4, and a forced return instruction unit 2H that compares the used electric energy W3 of the secondary battery 4 integrated by the secondary battery used electric energy integration unit 2G with the total electric energy W0 of the secondary battery 4 stored in the memory 2B and, when the used electric energy W3 of the secondary battery 4 is equal to or larger than the total electric energy W0, sends a forced return instruction to the normal operation to the output control unit 2D.

Note that in the second exemplary embodiment as well, the output suppression time zone TS is designated in advance as the time zone of 8:00 to 20:00, as in the first exemplary embodiment. Additionally, the control unit 2-4 is implemented by hardware including a processor and a storage device and programs that implement various functions in cooperation with the hardware. The forced return instruction unit 2H has a function of resetting the timer of the output suppression time zone setting unit 2A and a function of discarding the integrated value of used electric energy in the secondary battery used electric energy integration unit 2G in addition to the function of sending the forced return instruction to the normal operation to the output control unit 2D. The secondary battery used electric energy integration unit 2G has a function of, upon receiving a timer count end signal from the output suppression time zone setting unit 2A, discarding the integrated value W3 of used electric energy of the secondary battery 4 up to the time.

In the second exemplary embodiment, the output control unit 2D controls the operations of a rectifying unit 2-1 and a charge/discharge unit 2-2 in the [symbol] way.

The output control unit 2D performs a normal control operation (normal operation) for the rectifying unit 2-1 and the charge/discharge unit 2-2 until the current time reaches the start time ts of the output suppression operation. In this normal operation, the charge/discharge unit 2-2 is set in the charge mode to charge the secondary battery 4 by the power from the rectifying unit 2-1. In addition, the power consumption of the DC communication device load 3 is wholly covered by the power from the rectifying unit 2-1.

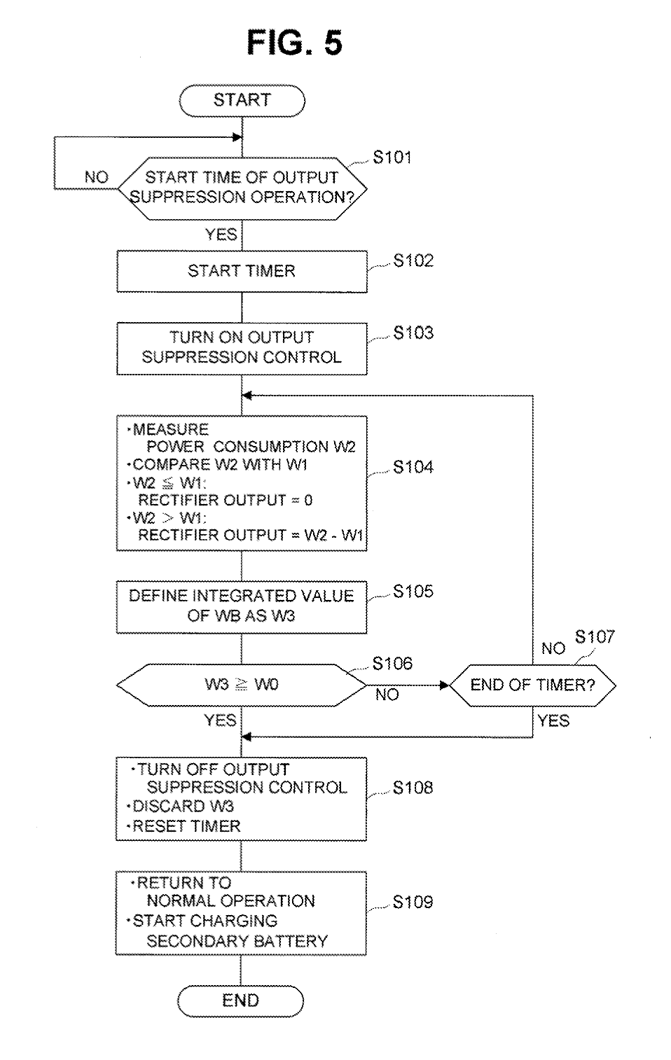

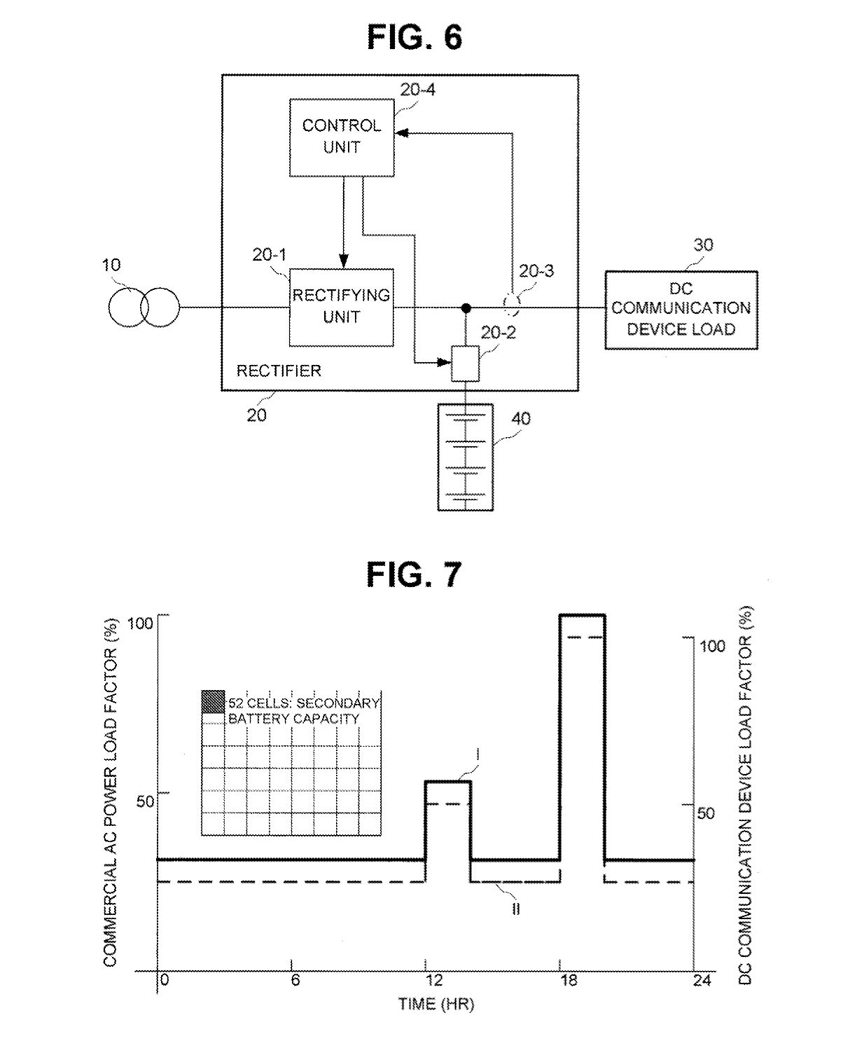

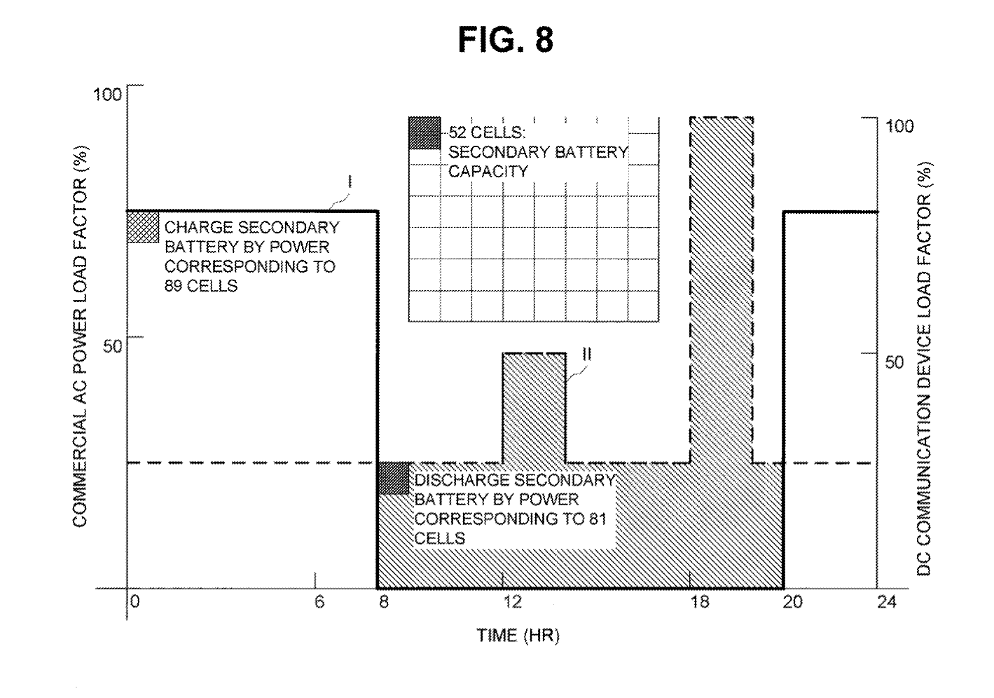

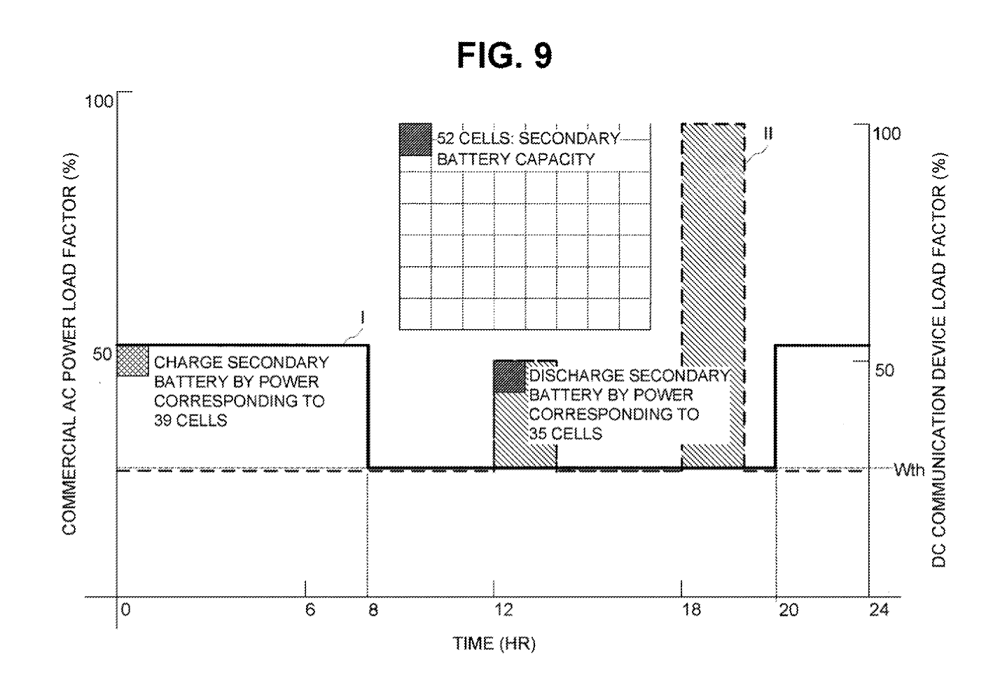

When the current time has reached the point ts of the output suppression operation (YES in step S101 of FIG. 5 (the point ts shown in FIG. 2)), the output suppression time zone setting unit 2A starts the timer to count time (step S102), and sends the timer count signal to the output control unit 2D and the secondary battery used electric energy integration unit 2G.

The output control unit 2D turns on output suppression control (step S103) to start the suppression operation of the output from the rectifying unit 2-1 (step S104). In this case, the output control unit 2D compares a current power consumption W2 of the DC communication device load 3 from a power consumption measuring unit 2C with the threshold W1 stored in the [symbol] If the current power consumption W2 of the DC communication device load 3 is equal to or smaller than the threshold W1 (W2≦W1), the output control unit 2D stops power supply from the rectifying unit 2-1 to the DC communication device load 3 (rectifier output=0). The output control unit 2D then sets the charge/discharge unit 2-2 in the discharge mode to cover the power consumption W2 only by the power accumulated in the secondary battery 4. If the current power consumption W2 of the DC communication device load 3 exceeds the threshold W1 (W2>W1), the power consumption up to the threshold W1 is covered by the [symbol] in the secondary battery 4 while the power consumption more than the threshold W1 is covered by the power from the rectifying unit 2-1 (rectifier output−W2−W1).

On the other hand, upon receiving the timer count signal sent from the output suppression time zone setting unit 2A, the secondary battery used electric energy integration unit 2G starts integrating the supply power WB from the secondary battery 4 to the DC communication device load 3, which is measured by the secondary battery supply power measuring unit 2F, and sends the integrated electric energy to the forced return instruction unit 2H as the used electric energy W3 of the secondary battery 4 (step S105).

The processing operation of steps S104 and S105 is repeated. During the repetition of the processing operation, if the timer count of the output suppression time zone setting unit 2A ends, and the current time falls outside the output suppression time zone TS (YES in step 5107 (the point to shown in FIG. 2)) before the used electric energy W3 of the secondary battery 4 integrated by the secondary battery used electric energy integration unit 2G becomes equal to or larger than the total electric energy W0 stored in the memory 2B (NO in step S106), the output control unit 2D turns off the output suppression control (step S108) to return to the normal control operation before the output suppression time zone TS starts (step S109). That is, the output control unit 2D returns to the normal operation, and sets the charge/discharge unit 2-2 in the charge mode to start charging the secondary battery 4 by the power from the rectifying unit 2-1. The power consumption of the DC communication device load 3 is wholly covered by the power from the rectifying unit 2-1. At this time, the secondary battery used electric energy integration unit 2G receives the timer count end signal from the output suppression time zone setting unit 2A and discards the integrated value W3 of used electric energy of the secondary battery 4 up to the time (step S108).

Note that if the used electric energy W3 of the secondary battery 4 integrated by the secondary battery used electric energy integration unit 2G becomes equal to or larger than the total electric energy W0 stored in the memory 2B (YES in step S106) before the current time falls outside the output suppression time zone TS, the forced return instruction unit 2H sends a forced return instruction to the normal operation to the output control unit 2D.

The output control unit 2D thus turns off the output suppression control (step S108) to return to the normal control operation before the output suppression time zone TS starts (step S109). That is, if power equal to or larger than the total electric energy W0 is used in the secondary battery 4, the output control unit 2D immediately stops output suppression control, and returns to the normal control operation before the output suppression time zone TS starts to start charging the secondary battery 4.

The forced return instruction unit 2H sends the forced return instruction to the normal operation to the output control unit 2D, and simultaneously resets the timer of the output suppression time zone setting unit 2A to discard the integrated value W3 of the used electric energy of the secondary battery 4 in the secondary battery used electric energy integration unit 2G (step S108).

In the second exemplary embodiment, the output suppression time zone setting unit 2A corresponds to an output suppression time zone setting means of the present invention, the memory 2B corresponds to a threshold storage means and a total electric energy storage means, the power consumption measuring unit 2C corresponds to a power consumption measuring means, the output control unit 2D corresponds to an output control means, the threshold & total electric energy calculation unit 2E corresponds to a threshold calculation means and a total electric energy calculation means, the secondary battery used electric energy integration unit 2G corresponds to a used electric energy integration means, and the forced return instruction unit 2H corresponds to a normal operation return means.

The present invention has been described above with reference to the exemplary embodiments. However, the present invention is not limited to the above exemplary embodiments. Various changes and modifications understandable by those who skilled in the art can be done for the arrangements and details of the present invention without departing the scope of the present invention.

This application is based upon and claims the benefit of priority from Japanese patent application No. 2009-98839, filed on Apr. 15, 2009, the disclosure of which is incorporated herein in its entirety by reference.

### INDUSTRIAL APPLICABILITY

The DC power supply system and the output control method of the present invention are usable in various fields using a rectifier and a secondary battery as a DC power supply system which supplies power to a DC load such as a DC communication device load whose power consumption varies and an output control method.

### EXPLANATION OF THE REFERENCE NUMERALS AND SIGNS

1 . . . commercial AC power supply, 2 . . . rectifier, 2-1 . . . rectifying unit, 2-2 . . . charge/discharge unit, 2-3 . . . feedback information monitoring unit, 2-4 . . . control unit, 2-5 . . . secondary battery feedback information monitoring unit, 2A . . . output suppression time zone setting unit, 2B . . . memory, 2C . . . power consumption measuring unit, 2D . . . output control unit, 2E . . . threshold & total electric energy calculation unit, 2F . . . secondary battery supply power measuring unit, 2G . . . secondary battery used electric energy integration unit, 2H . . . forced return instruction unit, 3 . . . DC communication device load, TS . . . output suppression time zone

1. A DC power supply system comprising:
a DC load whose power consumption varies;
a rectifying unit that rectifies and converts AC power into DC power;
a secondary battery to be charged upon receiving the DC power supplied from said rectifying unit;
an output suppression time zone setting unit that sets an output suppression time zone defined as a desired time zone;
a threshold storage unit that stores, as a threshold, suppliable power per unit time from said secondary battery to said DC load during the output suppression time zone;
a power consumption measuring unit that measures a current power consumption of said DC load;
an output control unit that, during the output suppression time zone, compares the threshold with the current power consumption of said DC load measured by said power consumption measuring unit, if the current power consumption of said DC load is not more than the threshold, stops power supply from said rectifying unit to said DC load and covers the power consumption only by power accumulated in said secondary battery, and if the current power consumption of said DC load is more than the threshold, covers the power consumption up to the threshold by the power accumulated in said secondary battery and covers the power consumption more than the threshold by power from said rectifying unit.

2. A DC power supply system according to claim 1, further comprising a threshold calculation unit that obtains the threshold from a capacity of said secondary battery, a limit of a depth of discharge arbitrarily set for said secondary battery, and a time width of the output suppression time zone.

3. A DC power supply system according to claim 1, further comprising:
a total electric energy storage unit that stores a total electric energy suppliable from said secondary battery to said DC load;
a used electric energy integration unit that integrates the supply power from said secondary battery to said DC load during the output suppression time zone as a used electric energy of said secondary battery; and
a normal operation return unit that, when the used electric energy of said secondary battery integrated by said used electric energy integration unit is not less than the total electric energy, stops an output suppression operation by said output control unit in the output suppression time zone and returns to a normal control operation before a start of the output suppression time zone.

4. A DC power supply system according to claim 3, further comprising a total electric energy calculation unit that obtains the total electric energy from a capacity of said secondary battery and a limit of a depth of discharge arbitrarily set for said secondary battery.

5. A DC power supply system according to claim 1, wherein said output suppression time zone setting unit starts a timer to count a predetermined time width from a point of time a current time has reached a start time of an output suppression operation and sets a time zone until an end of count of the timer as the output suppression time zone.

6. An output control method applied to a DC power supply system including:
a DC load whose power consumption varies;
a rectifying unit that rectifies and converts AC power into DC power; and
a secondary battery to be charged upon receiving the DC power supplied from the rectifying unit, comprising:
the output control step of comparing a stored threshold with a power consumption of the DC load, if the power consumption of the DC load is not more than the threshold, stopping power supply from the rectifying unit to the DC load and covering the power consumption only by power accumulated in the secondary battery, and if the power consumption of the DC load is more than the threshold, covering the power consumption up to the threshold by the power accumulated in the secondary battery and covering the power consumption more than the threshold by power from the rectifying unit.

7. An output control method according to claim 6, further comprising the steps of:
setting an output suppression time zone defined as a desired time zone;
storing, as the threshold, suppliable power per unit time from the secondary battery to the DC load during the output suppression time zone; and
measuring a current power consumption of the DC load,
wherein in the output control step,
during the output suppression time zone, the measured current power consumption of the DC load is compared with the threshold, if the current power consumption of the DC load is not more than the threshold, power supply from the rectifying unit to the DC load is stopped, and the power consumption is covered only by power accumulated in the secondary battery, and if the current power consumption of the DC load is more than the threshold, the power consumption up to the threshold is covered by the power accumulated in the secondary battery, and the power consumption more than the threshold is covered by power from the rectifying unit.

8. A DC power supply system comprising:
a DC load whose power consumption varies;
a rectifying unit that rectifies and converts AC power into DC power;
a secondary battery to be charged upon receiving the DC power supplied from said rectifying unit;
output suppression time zone setting means for setting an output suppression time zone defined as a desired time zone;
threshold storage means for storing, as a threshold, suppliable power per unit time from said secondary battery to said DC load during the output suppression time zone;
power consumption measuring means for measuring a current power consumption of said DC load;
output control means for, during the output suppression time zone, comparing the threshold with the current power consumption of said DC load measured by said power consumption measuring means, if the current power consumption of said DC load is not more than the threshold, stopping power supply from said rectifying unit to said DC load and covering the power consumption only by power accumulated in said secondary battery, and if the current power consumption of said DC load is more than the threshold, covering the power consumption up to the threshold by the power accumulated in said secondary battery and covering the power consumption more than the threshold by power from said rectifying unit.
